(19) United States
(12) Patent Application Publication
(10) Pub. No.: US 2011/0030497 A1
(43) Pub. Date: Feb. 10, 2011

(54) SELF-ADJUST MECHANISM FOR PARKING BRAKE ASSEMBLY

(76) Inventor: Nebojsa Djordjevic, Toronto (CA)

Correspondence Address: MAGNA INTERNATIONAL, INC., 337 MAGNA DRIVE, AURORA, ON, L4G-7K1, CA

(21) Appl. No.: 12/988,011

(22) PCT Filed: Apr. 17, 2009
(86) PCT No.: PCT/CA09/00472

§ 371 Date: Oct. 15, 2010

Related U.S. Application Data
(60) Provisional application No. 61/045,674, filed on Apr. 17, 2008.

(51) Int. Cl. B60T 7/10; F16C 1/22; F16C 1/10; F16D 65/54

(52) U.S. Cl. 74/501.5 R; 74/502.2

(57) ABSTRACT

In another particular embodiment, a parking brake assembly is provided and includes a parking brake lever, a first locking member that is connectable to the parking brake cable, a second locking member and a spring. The parking brake lever is operatively connected to the second locking member for movement between a locking position wherein the second locking member engages the first locking member and locks the first locking member for movement with the parking brake lever in a first direction, and an unlocking position wherein the second locking member unlocks the first locking member from the parking brake lever during movement of the parking brake lever in the first direction. The spring is positioned to apply a tensioning force to the parking brake cable and is positioned to bias the second locking member towards the locking position.

### FIELD OF THE INVENTION

The present invention relates to a parking brake assembly, and more particularly to a parking brake assembly that includes a self-adjust mechanism.

### BACKGROUND OF THE INVENTION

A parking brake for a vehicle is typically actuated by a cable that is connected to a hand- or foot-operated lever mounted in the vehicle's cabin. Over time, with repeated actuations the cable can stretch, however. With some parking brake assembly designs, when a cable became stretched there would be an initial amount of lever travel that would simply take up the slack in the cable without actuating the brake. As a result, as the cable stretches over time, a progressively greater amount of lever travel would be required to actuate the brake.

Some parking brakes have been proposed which include a self-adjust mechanism so that even after the cable stretches the system eliminates the slack in the cable. As a result, the same amount of lever travel is required regardless of whether the cable has stretched over time. Such self-adjust mechanisms typically involve many components, which can augment the cost of the parking brake assembly, and which can add to the size of the assembly. It would be advantageous to provide a parking brake assembly with a self-adjust mechanism that involves relatively fewer components and/or at a relatively lower cost.

### SUMMARY OF THE INVENTION

In a first aspect, the invention is directed to a parking brake assembly with a self-adjust mechanism that uses a single spring to tension a parking brake cable and to bias first and second locking members towards locking the parking brake cable for movement with a parking brake lever during movement of the parking brake lever towards a brake actuation position.

In a particular embodiment, the parking brake assembly includes a first ratchet member that is connectable to the parking brake cable, a second ratchet member, a parking brake lever operatively connected to the second ratchet member, and a spring that is positioned to urge the first and second ratchet members in opposite directions and is positioned to bias the second ratchet member towards locking the first ratchet member for movement with the parking brake lever towards a brake actuation position.

In another particular embodiment, the parking brake assembly includes a parking brake lever, a first locking member that is connectable to the parking brake cable, a second locking member and a spring. The parking brake lever is operatively connected to the second locking member for movement between a locking position wherein the second locking member engages the first locking member and locks the first locking member for movement with the parking brake lever in a first direction, and an unlocking position wherein the second locking member unlocks the first locking member from the parking brake lever during movement of the parking brake lever in the first direction. The spring is positioned to apply a tensioning force to the parking brake cable and is positioned to bias the second locking member towards the locking position.

In yet another particular embodiment, the parking brake assembly includes a parking brake lever that is movable between a home position and a brake actuation position, a lock housing movable by the parking brake lever, a first locking member that is connectable to the parking brake cable, a second locking member that is movable relative to the lock housing between a locking position wherein the second locking member engages the first locking member and locks the first locking member for movement with the lock housing in a first direction, and an unlocking position wherein the second locking member unlocks the first locking member from the lock housing during movement of the lock housing in the first direction, and a spring that is positioned to apply a tensioning force to the parking brake cable and is positioned to bias the second locking member towards the locking position. The lock housing is movable by the parking brake lever between a home position, a parking brake cable locking position, and a brake actuation position. In the home position the second locking member is in the unlocking position, the spring is positioned to exert a tensioning force on the parking brake cable and the first locking member is positioned for non-actuation of the parking brake. In the parking brake cable locking position the second locking member is in the locking position and the first locking member is positioned for non-actuation of the parking brake. In the brake actuation position the second locking member is in the locking position and the first locking member is positioned for actuation of the parking brake.

### BRIEF DESCRIPTION OF THE DRAWINGS

The present invention will now be described by way of example only with reference to the attached drawings, in which:

FIG. 1 is an elevation view of a parking brake assembly for controlling a parking brake cable for a parking brake in accordance with an embodiment of the present invention, in a first position;

FIG. 1a is a magnified elevation view of the parking brake assembly shown in FIG. 1;

FIG. 2 is a magnified elevation view of the parking brake assembly shown in FIG. 1, in a second position;

FIG. 3 is an elevation view of the parking brake assembly shown in FIG. 1, in a third position;

FIG. 3a is a magnified elevation view of the parking brake assembly shown in FIG. 1, in the third position;

FIG. 4 is a perspective view of the parking brake assembly shown in FIG. 1;

FIG. 5 is a perspective view of a portion of the parking brake assembly shown in FIG. 1;

FIG. 6 is an elevation view of a parking brake assembly in accordance with another embodiment of the present invention;

FIG. 7a is a magnified sectional elevation view of a portion of the parking brake assembly shown in FIG. 6, in a first position; and

FIG. 7b is a magnified sectional elevation view of a portion of the parking brake assembly shown in FIG. 6, in a second position.

### DETAILED DESCRIPTION OF THE INVENTION

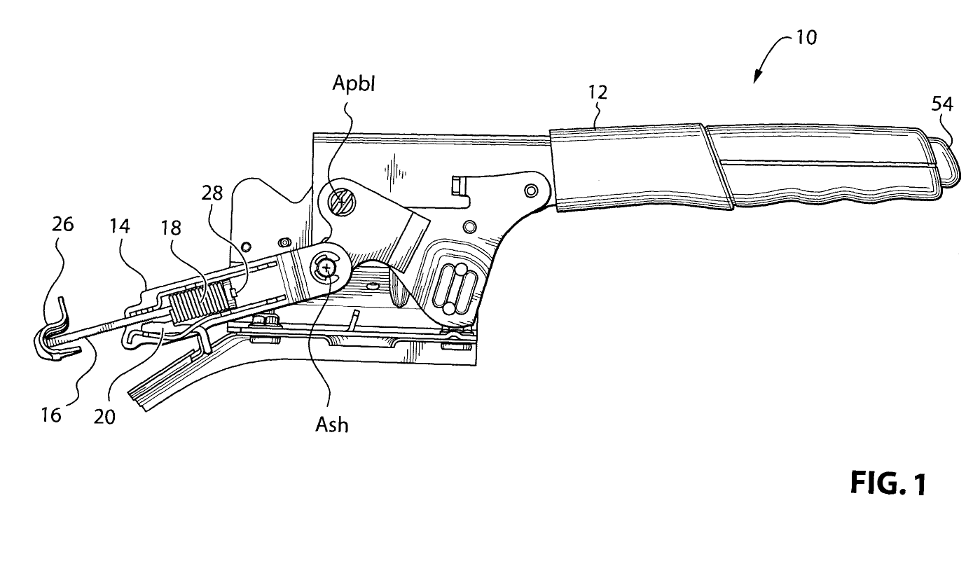

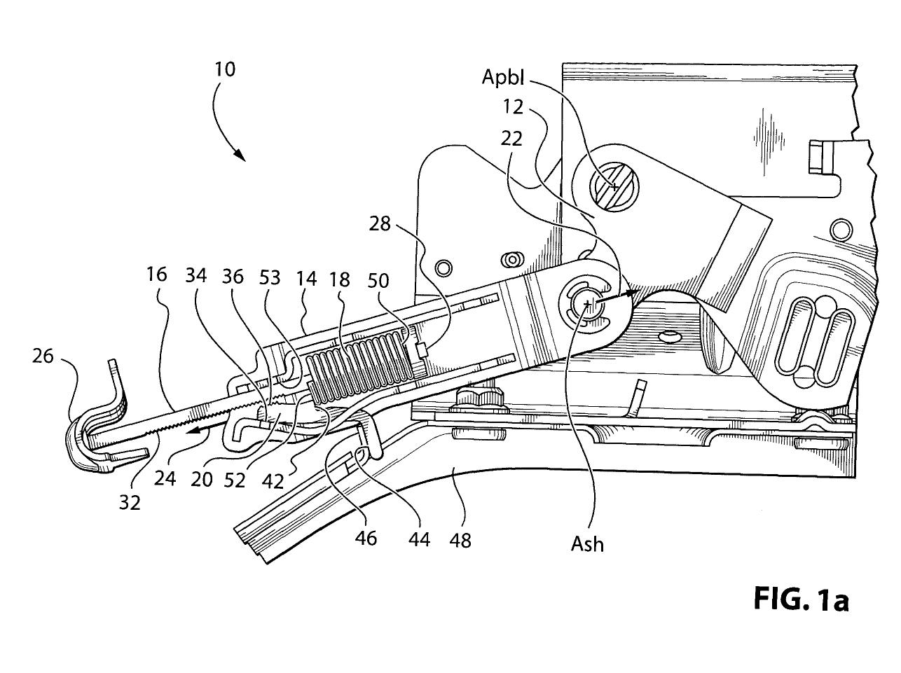

Reference is made to FIG. 1, which a shows parking brake assembly 10 for controlling a parking brake cable (not shown) for a vehicular parking brake (not shown), in accordance with an embodiment of the present invention. The parking brake assembly 10 includes a parking brake lever 12, a lock housing 14, a first locking member 16, a spring 18 and a second locking member 20.

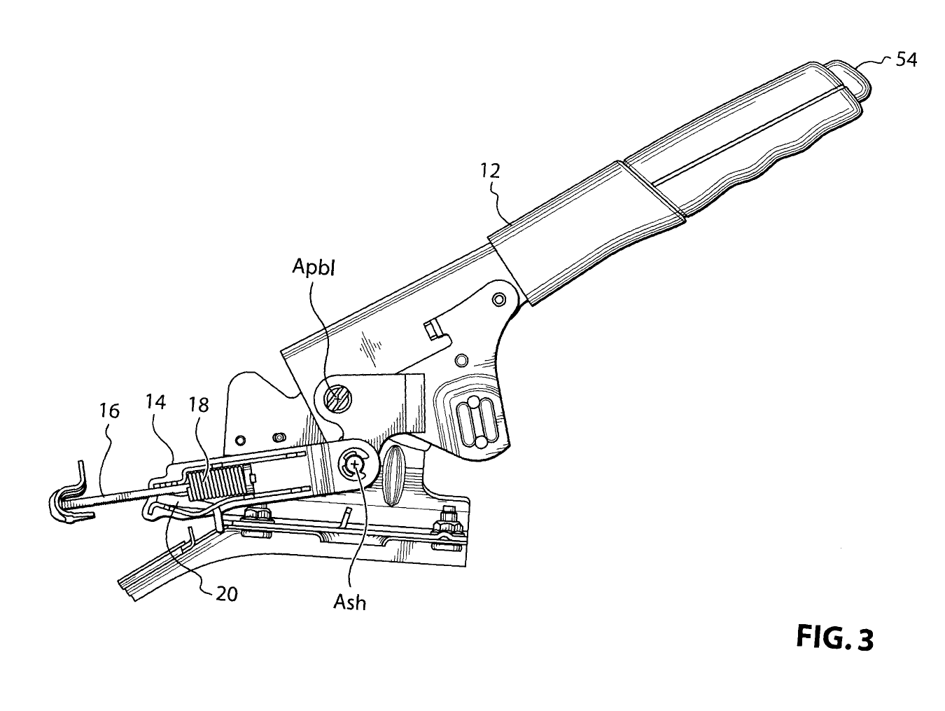

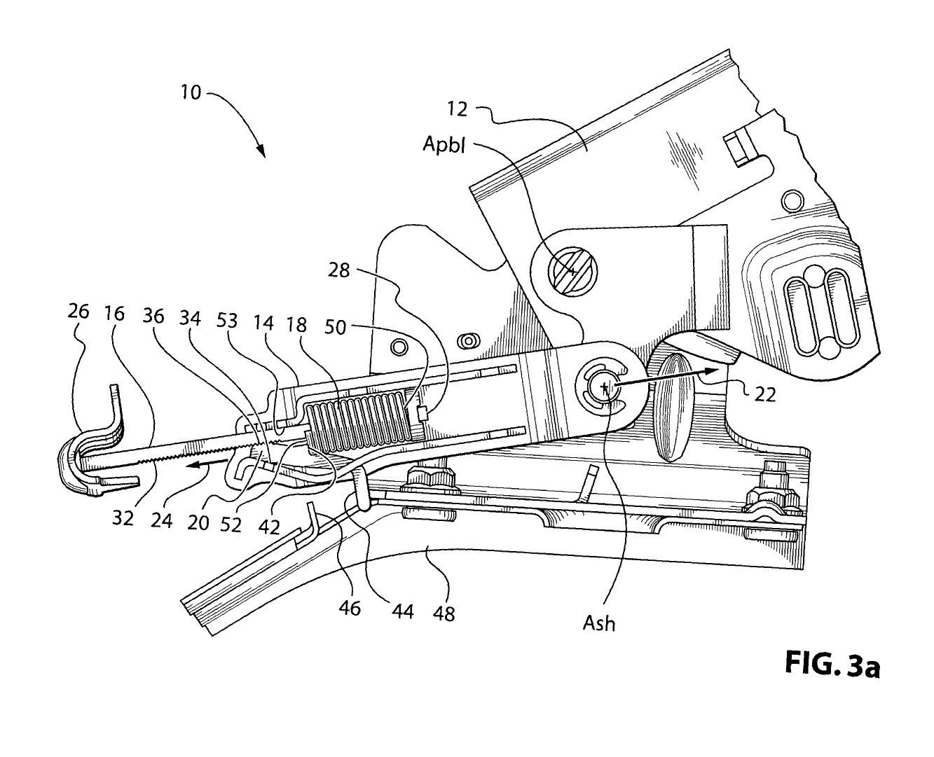

The parking brake lever 12 is mounted for rotation about a parking brake lever axis Apbl. The parking brake lever 12 is shown as being a hand-operated lever, however it is alternatively possible for the parking brake lever to be a foot-operated lever. The parking brake lever 12 is movable between a home position shown in FIGS. 1 and 1a and a brake actuation position shown in FIGS. 3 and 3a. The brake actuation position may be any position over a range depending on the amount of force with which a vehicle occupant operates the parking brake lever 12. The parking brake lever 12 may include a ratchet mechanism to hold it at a given brake actuation position, and may be biased towards the position shown in FIGS. 1 and 1a.

Referring to FIG. 1a, the lock housing 14 is rotatably mounted to the parking brake lever 12, about an axis Ash. The lock housing 14 is movable by the parking brake lever 12 in a first direction 22 and in a second direction 24. The movement of the lock housing 14 is discussed further below.

The first locking member 16 has a first end 26 and a second end 28. The first end 26 is connectable to the parking brake cable (not shown). The second end 28 is engaged with the spring 18. The first locking member 16 has thereon a first set of teeth 32 which are described further below.

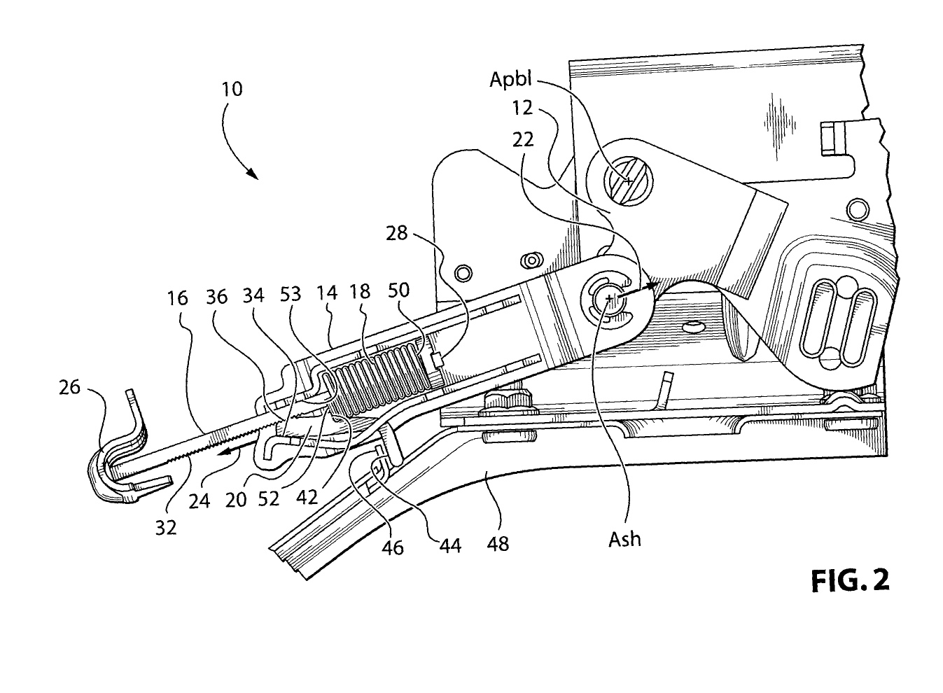

The second locking member 20 is movable along a wedging surface 34 of the lock housing 14, between a locking position (FIG. 2) and an unlocking position (FIGS. 1 and 1a). In the locking position the second locking member 20 engages the first locking member 16 and locks the first locking member 16 (and therefore the parking brake cable) to the lock housing 14 (and therefore the parking brake lever for movement in the first direction 22, which is towards the brake actuation position. In other words, when the second locking member 20 is in the locking position, the first locking member 16 and the associated parking brake cable are locked for movement with the lock housing and the parking brake lever 12 in the first direction 22 towards the brake actuation position. In this way, movement of the lock housing 14 in the first direction 22 actuates the parking brake. In the unlocking position (FIGS. 1 and 1a) the second locking member 20 permits movement of the first locking member 16 relative to the lock housing 14 in both the first and second directions 22 and 24. Therefore, when the second locking member 20 is in the unlocking position, the spring 18 acts on the first locking member 16 to tension the parking brake cable.

The engagement of the second locking member 20 with the first locking member 16 when the second locking member 20 is in the locking position may be any suitable type of engagement. For example, the second locking member 20 may have thereon a second set of teeth 36 for engaging the first set of teeth 34 on the first locking member 16. As a result of the first and second locking members 16 and 20 having the meshable sets of teeth 32 and 36, the first and second locking members 16 and 20 may be referred to as first and second ratchet members.

The second locking member 20 has a spring engagement shoulder 42 that is positioned to engage the spring 18. The second locking member 20 further includes an unlocking member engagement surface 44 that is configured to engage an unlocking member 46, at a selected point along the travel of the lock housing 14. The unlocking member 46 is mounted on a stationary structure of the vehicle, shown at 48.

The spring 18 has a first end 50 that is engaged with the second end 28 of the first locking member 16. The spring 18 has a second end 52 that is engaged with the spring engagement shoulder 42. The spring 18 thus is positioned to apply a tensioning force to the parking brake cable (not shown), though the first locking member 16. Additionally, the spring 18 is positioned to bias the second locking member 20 along the wedging surface 34 towards the locking position (FIG. 2).

In the embodiment shown in the figures, the spring 18 urges the first and second locking members 16 and 20 in opposite directions. The spring 18 may be any suitable type of spring, such as, for example, a compression spring.

The lock housing 14 is movable by the parking brake lever 12 between a home position, shown in FIGS. 1 and 1a, a parking brake cable locking position shown in FIG. 2 and a brake actuation position shown in FIGS. 3 and 3a. In the home position (FIGS. 1 and 1a), the second locking member 20 is in the unlocking position and the first locking member is positioned for non-actuation of the parking brake. In the parking brake cable locking position (FIG. 2), the second locking member 20 is in the locking position and the first locking member 16 is positioned for non-actuation of the parking brake is not actuated. In the brake actuation position (FIGS. 3 and 3a), the second locking member 20 is in the locking position and the first locking member 16 is positioned for actuation of the parking brake.

When the parking brake assembly 10 is in the position shown in FIG. 1, the spring 18 is under some compression, thereby maintaining a tensile force on the first locking member 16 and therefore on the parking brake cable (not shown). Also, the spring 18 urges the second locking member 20 towards its locking position (FIGS. 3 and 3a), however, the second locking member 20 is prevented from moving to its locking position because of its engagement with the unlocking member 46.

When a vehicle occupant (not shown) wishes to actuate the parking brake (not shown), he or she moves the parking brake lever 12 from its home position towards its brake actuation position. The parking brake lever 12 is operatively connected to the lock housing and therefore to the second locking member 20 for movement between the locking position and the unlocking position. The movement of the parking brake lever 12 towards its brake actuation position moves the lock housing 14 from its home position in its first direction 22 towards its brake actuation position (FIG. 3). As the lock housing 18 initially moves away from its home position (FIGS. 1 and 1a), there is substantially no movement of the first locking member 16 and so the parking brake remains unactuated. Instead, the second locking member 20 rides along the wedging surface 34 to its locking position, shown in FIG. 2, under the urging of the spring 18, where it engages the first locking member 16, by meshing of the first teeth 32 and second teeth 36. The wedging surface 34 cooperates with an opposing surface 53 to wedge the engaged first and second locking members 16 and 20 thereby locking the first locking member 16 and the parking brake cable with the lock housing 14 for movement in the first direction 22 towards the brake actuation position.

Further movement of the lock housing 40 to a brake actuation position (FIGS. 3 and 3a) by the parking brake lever 12 moves the first locking member 30 and the parking brake cable (not shown) to actuate the parking brake (not shown).

To release the parking brake, the vehicle occupant may push an optional release button shown at 54 (FIG. 3) on the parking brake lever 12, which disengages the optional ratchet mechanism therein (not shown). The parking brake lever 12 may then be moved from its brake actuation position (FIGS. 3 and 3a) towards its home position shown in FIGS. 1 and 1a. This movement of the parking brake lever 12 moves the lock housing 14 in the second direction 24 from its brake actuation position (FIGS. 3 and 3a) towards its home position (FIGS. 1 and 1a). At some point during the movement of the lock housing 14 towards its home position (FIGS. 1 and 1a), the parking brake (not shown) become unactuated. Further along during the movement of the lock housing 14 towards its home position the unlocking member engagement surface 44 on the second locking member 20 engages the unlocking member 46 preventing the second locking member 20 from traveling further with the lock housing 14 in the second direction 24. Thus, as the lock housing 14 travels in the second direction 24 past the point of engagement (FIG. 2) between the unlocking member 46 and the second locking member 20, the second locking member 20 is moved out of its locking position. When the lock housing 14 reaches its home position (FIGS. 1 and 1a), the second locking member is in its unlocking position.

After repeated use, the parking brake cable (not shown) may stretch. As a result, when the parking brake lever 12 and the lock housing 14 are in their respective home positions (FIGS. 1 and 1a) the spring 18 may be in a more relaxed state than before the parking brake cable became stretched. However, the spring 18 will remain somewhat flexed, (ie. compressed somewhat in the embodiment shown in the figures), and will thus maintain tension in the stretched parking brake cable, and maintain a biasing force on the second locking member 20 urging the second locking member 20 towards the locking position shown in FIG. 2.

It will be noted that movement of the second locking member 20 to its locking position (FIG. 2) takes place within a relatively short amount of travel of the parking brake lever 12 and lock housing 14. In this way, nearly all the travel of the parking brake lever 12 is used to pull the parking brake cable (not shown) to actuate the parking brake (not shown). It will also be noted that amount of travel required by the parking brake lever 12 and the lock housing 14 do not change significantly even after the parking brake cable stretches over time.

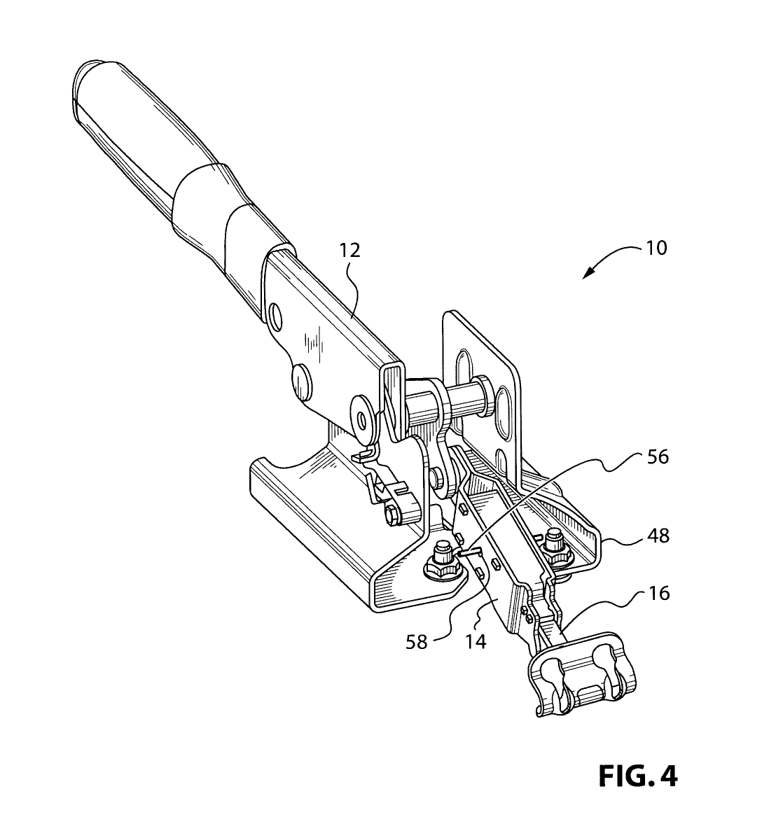

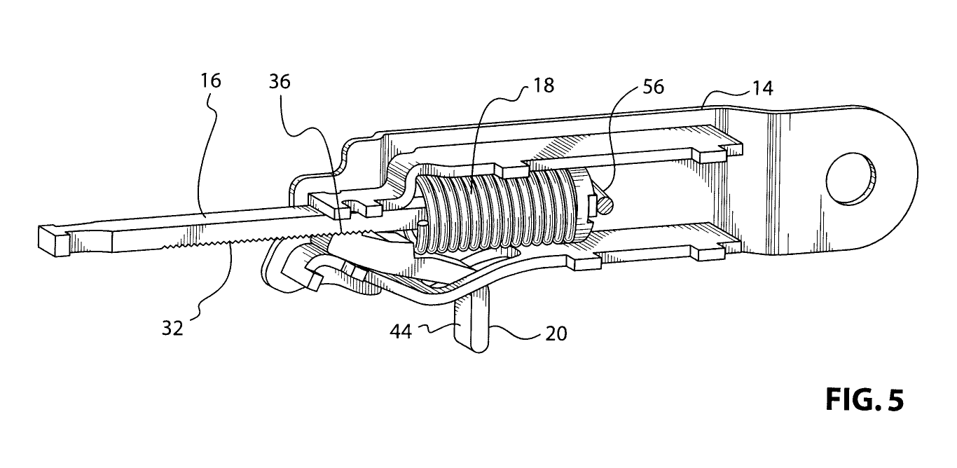

Referring to FIG. 4, prior to shipping of the parking brake assembly 10 from a manufacturer to a site for installation into a vehicle, a shipping pin 56 may be inserted through a shipping pin receiving aperture 58 in the lock housing 14. The shipping pin receiving aperture 58 may pass-through the entire lock housing so that the shipping pin 56 extends out of the lock housing 14 on both sides. The shipping pin receiving aperture 58 is positioned so that when the shipping pin 56 passes therethrough, it holds the spring 18 (FIG. 5) in a compressed state wherein the second locking member 20 may be in the locking position, which holds it with the rest of the parking brake assembly 10, thereby preventing the second locking member 20 from becoming separated from the rest of the parking brake assembly 10 during shipping. In addition, the compression of the spring 18 by the shipping pin 56 causes the first locking member 16 to extend outwards from the lock housing 14. This facilitates the attachment of the parking brake cable (not shown) to the parking brake assembly 10 during installation into a vehicle.

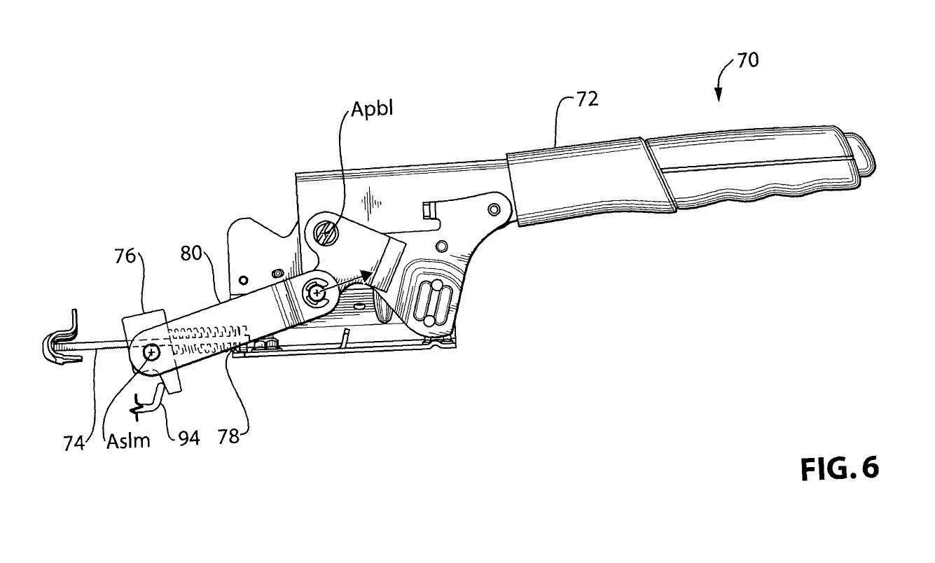

Reference is made to FIG. 6 which shows a parking brake assembly 70 in accordance with another embodiment of the present invention. The parking brake assembly 70 includes a parking brake lever 72, a first locking member 74, a second locking member 76 and a spring 78. The parking brake lever 72 may be similar to the parking brake lever 12 (FIG. 1) but instead of connecting to the spring housing 14 (FIG. 1), the parking brake lever 72 connects to an optional pivoting link 80, which in turn pivotably connects to the second locking member 76 for rotation about a pivot axis Asim.

The first locking member 74 may be similar to the first locking member 16 and includes a first set of teeth 82. The second locking member 76 includes a pass-through aperture 84 which permits the pass-through of the first locking member 74. In the pass-through aperture 84 there is a first surface 86 which includes a second set of teeth 88 thereon, which are engageable with the first set of teeth 82 on the first locking member 74. The first surface 86 further includes a slide surface 90, which is configured to permit sliding movement of the first locking member 74 thereon. The second locking member 76 further includes an unlocking member engagement surface 92 that is engageable with an unlocking member 94 mounted to a stationary part of the vehicle.

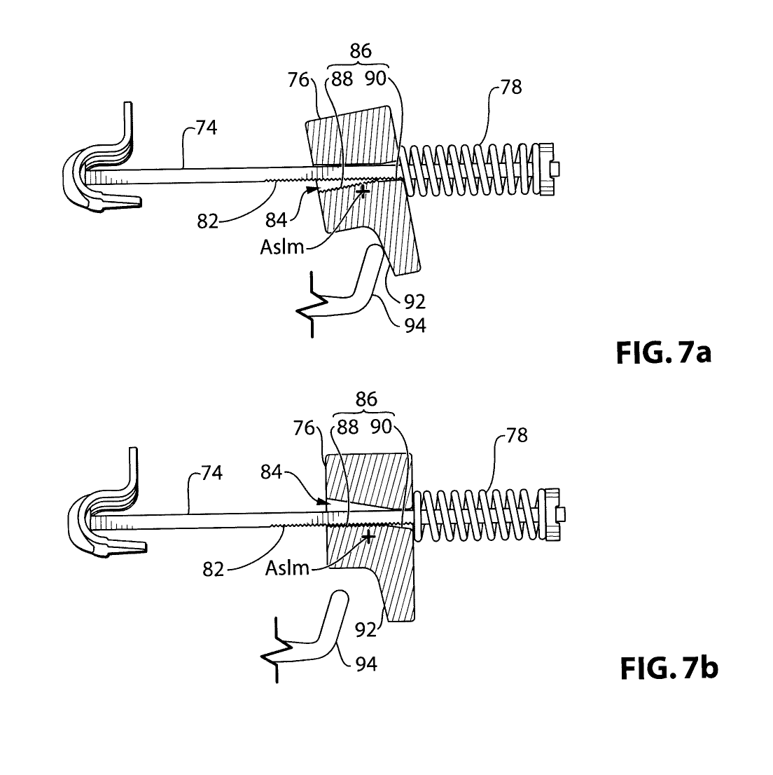

The spring 78 is positioned between the first locking member 74 and the second locking member 76 and urges them in opposite directions so that the first locking member 74 is in tension. Additionally, the spring 78 urges the second locking member 76 towards a locking position shown in FIG. 7b, in which the second set of teeth 88 engage the first set of teeth 82 thereby locking the first locking member 74 for movement with the second locking member in the first direction shown at 96 (FIG. 6). Thus, the engagement of the first and second sets of teeth 82 and 88 locks the first locking member 74 for movement with the parking brake lever 72 towards the brake actuation position.

When the parking brake lever 72 is in the home position (shown in FIG. 6), the unlocking member engagement surface 92 engages the unlocking member 94, which causes the second locking member 76 to pivot (counterclockwise in the view shown in FIGS. 7a and 7b) to an unlocking position shown in FIG. 7a. In the unlocking position, the second set of teeth 88 on the second locking member 76 are disengaged from a first set of teeth 82 on the first locking member 74. Instead, the slide surface 90 engages the first set of teeth 82 which permits the first locking member 74 to slide relative to the second locking member 76, which permits the first locking member 74 to be in tension under the urging of the spring 78.

It will be noted that the first direction 96 (FIG. 6) need not be in any particular direction, except that it is a direction that cause the brake cable (not shown) to be pulled and thereby actuated.

When the parking brake lever 72 is actuated, (ie. rotated counterclockwise in the view shown in FIG. 6), the second locking member 76 is moved in the first direction 96 (FIG. 6). As the second locking member 76 moves away from the unlocking member 94 the spring 78 urges it to rotate clockwise to its locking position as shown in FIG. 7b, wherein the first set of teeth 82 engages the second set of teeth 88.

While the above description constitutes a plurality of embodiments of the present invention, it will be appreciated that the present invention is susceptible to further modification and change without departing from the fair meaning of the accompanying claims.

1. A parking brake assembly for controlling a parking brake cable for a parking brake, comprising:
a first ratchet member that is connectable to the parking brake cable;
a second ratchet member;
a parking brake lever operatively connected to the second ratchet member; and
a spring that is positioned to urge the first and second ratchet members in opposite directions and is positioned to bias the second ratchet member towards locking the first ratchet member for movement with the parking brake lever towards a brake actuation position.

2. A parking brake assembly as claimed in claim 1, wherein the spring is a compression spring.

3. A parking brake assembly as claimed in claim 1, further comprising an unlocking member that is positioned to engage the second ratchet member and prevent the second ratchet member from locking the first ratchet member for movement with the parking brake lever towards a brake actuation position, wherein the parking brake lever is operatively connected to the second ratchet member to selectively bring the second ratchet member into and out of engagement with the unlocking member.

4. A parking brake assembly for controlling a parking brake cable for a parking brake, comprising:
a parking brake lever;
a first locking member that is connectable to the parking brake cable;
a second locking member, wherein the parking brake lever is operatively connected to the second locking member for movement between a locking position wherein the second locking member engages the first locking member and locks the first locking member for movement with the parking brake lever in a first direction, and an unlocking position wherein the second locking member unlocks the first locking member from the parking brake lever during movement of the parking brake lever in the first direction; and
a spring that is positioned to apply a tensioning force to the parking brake cable and is positioned to bias the second locking member towards the locking position.

5. A parking brake assembly as claimed in claim 4, wherein the spring has a first end that is engaged with the first locking member and a second end that is engaged with the second locking member.

6. A parking brake assembly as claimed in claim 5, wherein the spring is a compression spring.

7. A parking brake assembly as claimed in claim 4, wherein the first locking member includes first teeth and wherein the second locking member includes second teeth that are meshable with the first teeth for engagement of the second locking member with the first locking member.

8. A parking brake assembly as claimed in claim 1, further comprising an unlocking member that is positioned to engage the second locking member and prevent the second locking member from being in the locking position, wherein the parking brake lever is operatively connected to the second locking member to selectively bring the second locking member into and out of engagement with the unlocking member.

9. A parking brake assembly for controlling a parking brake cable for a parking brake, comprising:
a parking brake lever;
a lock housing;
a first locking member that is connectable to the parking brake cable;
a second locking member that is movable relative to the lock housing between a locking position wherein the second locking member engages the first locking member and locks the first locking member for movement with the lock housing in a first direction, and an unlocking position wherein the second locking member unlocks the first locking member from the lock housing during movement of the lock housing in the first direction; and
a spring that is positioned to apply a tensioning force to the parking brake cable and is positioned to bias the second locking member towards the locking position,
wherein the lock housing is movable by the parking brake lever between a home position, a parking brake cable locking position, and a brake actuation position,
wherein in the home position the second locking member is in the unlocking position, the spring is positioned to exert a tensioning force on the parking brake cable and the first locking member is positioned for non-actuation of the parking brake,
and wherein in the parking brake cable locking position the second locking member is in the locking position and the first locking member is positioned for non-actuation of the parking brake,
and wherein in the brake actuation position the second locking member is in the locking position and the first locking member is positioned for actuation of the parking brake.

10. A parking brake assembly as claimed in claim 9, wherein the spring has a first end that is engaged with the first locking member and a second end that is engaged with the second locking member.

11. A parking brake assembly as claimed in claim 10, wherein the spring is a compression spring.

12. A parking brake assembly as claimed in claim 9, wherein the first locking member includes first teeth and wherein the second locking member includes second teeth that are meshable with the first teeth for engagement of the second locking member with the first locking member.

13. A parking brake assembly as claimed in claim 9, further comprising an unlocking member that is positioned to prevent the second locking member from being in the locking position when the lock housing is positioned between the home position and the parking brake cable locking position.

14. A parking brake assembly as claimed in claim 13, wherein the unlocking member removes the second locking member from the locking position when the lock housing moves past the parking brake cable locking position towards the home position.

15. A parking brake assembly as claimed in claim 9, wherein the lock housing includes a wedging surface, wherein the second locking member is movable along the wedging surface to the locking position.

16. A parking brake assembly as claimed in claim 15, wherein the lock housing includes an opposing surface to the wedging surface, wherein, when the second locking member is in the locking position and engages the first locking member, wedging surface and the opposing surface cooperate to wedge the first and second locking members and thereby lock the first locking member for movement with the lock housing towards the brake actuation position.

17. A parking brake assembly as claimed in claim 9, wherein the first locking member has a cable mounting end for receiving the parking brake cable, and wherein the parking brake assembly further comprises a shipping pin that is engaged with the lock housing at a selected position to flex the spring in such a way as to urge the cable mounting end away from the lock housing.
